(19) United States
(12) Patent Application Publication
(10) Pub. No.: US 2014/0329581 A1
(43) Pub. Date: Nov. 6, 2014

(54) Method for Operating a Cooperative Game

(71) Applicant: Bally Gaming, Inc., Las Vegas, NV (US)

(72) Inventor: Scott Thomas Hilbert, Sparks, NV (US)

(73) Assignee: Bally Gaming, Inc., Las Vegas, NV (US)

(21) Appl. No.: 14/073,027

(22) Filed: Nov. 6, 2013

Related U.S. Application Data
(60) Provisional application No. 61/818,846, filed on May 2, 2013.

(51) Int. Cl. G07F 17/32

(52) U.S. Cl. CPC G07F 17/3274
USPC 463/25

(57) ABSTRACT

A cooperative/competitive gaming system includes a plurality of gaming machines, a bonus server and a network for coupling the plurality of gaming machines to the bonus server. A method for operating a cooperative/competitive game includes providing two or more pools having respective levels. Two or more players are permitted to form groups. The groups are allowed to play for pool levels based on the number of players in the group.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Invention

This invention pertains generally to multilevel progressive gaming system. More particularly, this invention relates to multilevel gaming in association with cooperative/competitive gaming.

2. The Prior Art

Gaming systems have long included progressive jackpot arrangements in which a portion of each wager is added to the jackpot pool. A winning pattern on a gaming machine connected to such a network awards that progressive jackpot to the player. Gaming systems having multilevel progressive jackpots are also known. In such a system, several progressive jackpots are maintained. A portion of each wager is allocated to the different jackpot pools. Respectively different winning combinations on a gaming machine connected to such a network awards the corresponding jackpot to the player.

Cooperative and/or competitive gaming systems are also known. For example, in the Pirate Battle® game system, manufactured by WMS Corporation, a bank of four gaming machines is interconnected to present a bonus game which includes both a cooperative and a competitive component. In this system, two groups are formed by machine location. That is, players at red group gaming machines are in the red group and players at blue group gaming machines in the blue group. The red group competes with the blue group to win a bonus award. A first bonus battle is randomly triggered where each group gains based on wins from a free spin bonus that are increased by a group's multiplier. A second bonus battle is a warship cannon battle where red group and blue group shoot it out in a cannon battle where the outcome of the cannon battle is randomly determined. There is no mechanism to form groups or to choose to be part of a group or not. Neither is there a way to add more players to a group or for players to risk higher amounts for greater paying levels.

### BRIEF DESCRIPTION OF THE INVENTION

In accordance with principles of the present invention, a cooperative/competitive gaming system includes a plurality of gaming machines, a bonus server and a network coupling the plurality of gaming machines to the bonus server. A method for operating a cooperative/competitive game includes providing two or more pools having respective levels. Two or more players are permitted to form groups. The groups are allowed to play for pool levels based on the number of players in the group.

### BRIEF DESCRIPTION OF THE DRAWING

FIG. 1 is a block diagram of a gaming system according to principles of the present invention;

FIG. 2 is a more detailed block diagram of a system according to principles of the present invention;

FIG. 3 is a set of tables indicating a breakdown of wagers between base game and bonus game, for solo play and for groups of two to four players, all according to principles of the present invention;

FIG. 4 is a perspective view of a gaming machine in accordance with one or more embodiments;

FIGS. 5a and b are block diagrams of the physical and logical components of the gaming machine of FIG. 4 in accordance with one or more embodiments;

FIG. 6 is a block diagram of the logical components of a gaming kernel in accordance with one or more embodiments;

FIGS. 7a and b are schematic block diagrams showing the hardware elements of a networked gaming system in accordance with one or more embodiments;

FIG. 8 is a is a diagram showing an example of an architecture for tying a casino enterprise network to an external provider of games and content to Internet or broadband communication capable devices.

### DETAILED DESCRIPTION OF THE PREFERRED EMBODIMENTS

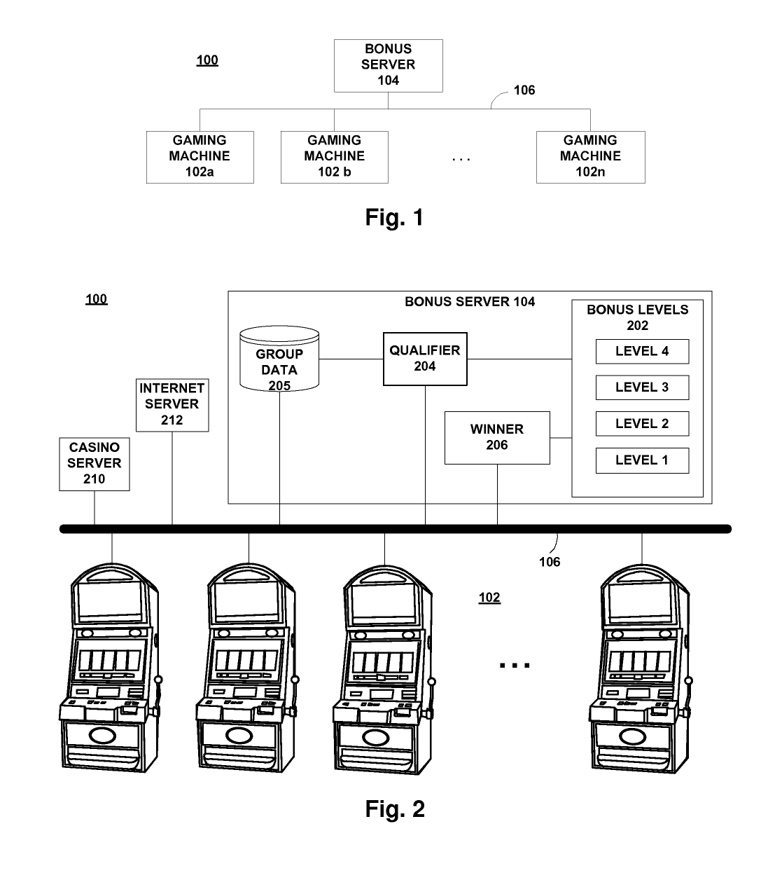

FIG. 1 is a block diagram of a gaming system 100 according to principles of the present invention. In FIG. 1, a plurality of gaming machines 102a-102n are coupled to a bonus server 104 via a network 106. In operation, cooperative play amongst two or more players, under control of the bonus server 104, enables the players to play for higher level, and higher value, bonus amounts. The bonus server 104 monitors transactions at the gaming machines 102. Two or more players are permitted to form a group (in a manner described in more detail below) and the bonus server retains information related to that group. If a player in a group at a gaming machine 102 performs an action qualifying for participation in a bonus game (also described in more detail below), the bonus server 104 determines which level bonus the group of players is eligible for. Further, when a winning combination occurs on an eligible gaming machine 102, the bonus server 104 determines the amount due to each player in the group (also described in more detail below).

FIG. 2 is a more detailed block diagram of a system 100 according to principles of the present invention. In FIG. 2, those elements which are the same as those illustrated in FIG. 1 are designated with the same reference number and are not described in detail below. In FIG. 2, a plurality 102 of gaming machines are coupled to a network 106. These gaming machines 102 may be located within a single bank, in multiple banks, or as individual games, linked across a property or multiple properties.

A bonus server 104 is illustrated including a set of bonus levels 202 including level 1, level 2, level 3 and level 4 level bonuses. The bonus levels include data representing the amount of money in each of the respective levels. In the illustrated embodiment, the respective levels are funded by buy-in wagers, also called side bets. In a different embodiment, the respective levels may be funded as progressives; i.e. they are funded by contribution of a fraction of the amounts wagered in the gaming machines 102. In a preferred embodiment, contributions to the progressive pool occur from any wager made in the gaming machine. In another embodiment, a higher fraction of the wager based on group play. Either one or both methods may be used. One skilled in the art understands that any appropriate method for funding the bonus levels may be used.

As described above, players are permitted for form groups or teams. In general, any way of forming groups is allowed. When formed, data representing groups is stored in a group data repository 205. There are different environments in which teams may be formed. In a first environment, a player at a gaming machine 102 may form a group. For example, a player may send a message to another player at another gaming machine 102 inviting him to form or join a group or indicating that the player would like to join a group. That player may accept the invitation and the two (or more) players are formed into a group. Alternatively, a player may broadcast such a request concurrently to all the gaming machines 102 connected to the bonus server 104. In another embodiment, players may be randomly assigned to a group. In another embodiment, players may be assigned to groups based on their respective wagers and/or playing style. In yet another embodiment, players may be assigned to groups based on enrollment in a player club. In yet another embodiment, players at the gaming machines 102 may activate a mechanism indicating that the player wishes to be in a team. The gaming machines 102 may cooperate to form a group of all the players who have made this indication. Data representing such groups are communicated from the gaming machines 102 to the group data repository 205 via the network 106.

In a second environment, a player on a property (e.g. in a casino or gaming establishment) may form a group via casino server 210. In one embodiment, a player may form a group by contacting the player club to acquire a partner or partners. This contact may be by any means, such as approaching a representative at a player club counter or using a player club kiosk. In another embodiment groups may be formed by a casino hosted tournament. In yet another embodiment, groups may be formed by a player at a casino kiosk. In a further embodiment, a player may leave an indication on the casino server 210 that they wish to be a member of a group. The casino server 210 forms a group of all the players who have made the indication that they wish to be in a group. Data representing such groups are communicated from the casino server 210 to the group data repository 205 via the network 106.

In a third environment, a player may form a group using networking such as the Internet and/or wired or wireless networking via Internet server 212. In one embodiment, a player may use a social networking site, such as FaceBook™, to locate partners and form groups. In another embodiment, a casino may host their own web sites or networking sites. A player may use such sites to locate partners and form groups. In another embodiment, a gaming company, such as Bally Gaming, Inc., may host web sites or networking sites. A player may use such sites to locate partners and form groups. In yet another embodiment, a player may use short messaging service (SMS) and/or other person-to-person text messaging services to locate partners and form groups, e.g. via mobile phones. Alternatively, networked messaging systems, such as Twitter™, may be used to locate partners and form groups. Using any of these mechanisms, a player may leave an indication that they wish to be a member of a group. The Internet server 212 forms a group of all the players who have made the indication that they wish to be in a group. Data representing such groups are communicated from the Internet server 212 to the group data repository 205 via the network 106.

Players may elect to join an existing group, or may form groups using any method described above. In addition, any appropriate method, known now or conceived later, of allowing players to form or join groups may be used. As described in detail above, data representing groups is stored in the group data repository 205, regardless of how those groups were formed. One skilled in the art understands that the techniques discussed above are examples, and that any technique may be used to locate partners and form groups.

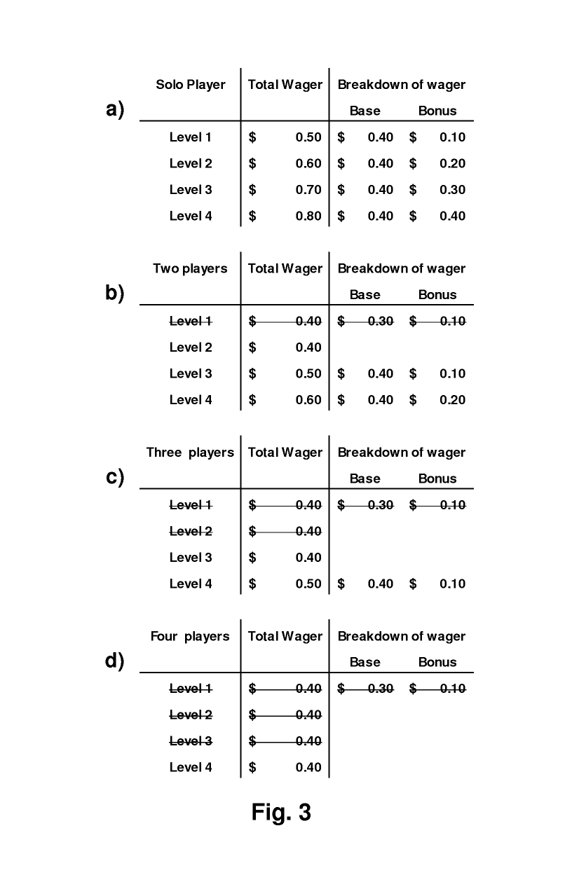

Groups are formed in order to allow those groups to play for higher bonus levels. In general, determining which bonus levels are made available to groups may be determined in any appropriate manner. FIG. 3 illustrates tables useful in understanding the operation of one embodiment for determining available bonus levels. FIG. 3a to d is a set of tables indicating a breakdown of wagers between base game and bonus game. FIG. 3a illustrates data for solo play, FIG. 3b illustrates data for groups of two, FIG. 3c illustrates data for groups of three and FIG. 3d illustrates data for groups of four players, all according to principles of the present invention.

In general, the bonus level which is played for depends on the number of players in a group. In the illustrated embodiment, four jackpot levels are available: level 1, level 2, level 3 and level 4 in bonus levels 202 (FIG. 2). Level 1 is the lowest level, and holds the least amount of money. Levels 2-4 are progressively higher levels holding progressively higher amounts of money. Groups of players qualify to play for different levels based on the number of players in the group. In addition, higher levels may be played for by making an additional buy-in wager.

In FIG. 3, each table is labeled based on the number of players in a group. The first column illustrates the bonus level, the second column illustrates the total wager required to play for the corresponding bonus level, and the third and fourth columns illustrate the allocation of the total wager to the base game and the bonus game, respectively. A basic wager amount is illustrated as $0.40 in FIG. 3. Referring now to FIG. 3b (Two players), the level 2 bonus is available to groups of two players. That is, belonging to a group of two players alone qualifies those players to play for the level 2 bonus for the basic wager and without requiring an additional bonus buy-in wager. Similarly, referring to FIG. 3c (Three players), the level 3 bonus is available to a groups of three players. That is, belonging to a group of three players alone qualifies those players to play for the level 3 bonus for the basic wager and without requiring a further bonus buy-in wager. In addition, referring to FIG. 3d (Four players), the level 4 bonus is available to groups of four players. That is, belonging to a group of four players alone qualifies those players to play for the level 4 bonus for the basic wager and without requiring a further bonus buy-in wager.

It is also possible for groups to play for higher level bonuses by wagering an additional buy-in wager to play for the higher bonus level. Referring to FIG. 3b, members of groups of two may play for bonus level 3 by wagering $0.50 in which $0.40 is allocated to the base game, and $0.10 is allocated as a buy-in to the level 3 bonus game. Similarly, groups of two may play for bonus level 4 by wagering $0.60 in which $0.40 is allocated to the base game, and $0.20 is allocated to the level 4 bonus game. Similarly, referring to FIG. 3c, members of groups of three may play for bonus level 4 by wagering $0.50 in which $0.40 is allocated to the base game and $0.10 is allocated to the bonus level 4 game.

In the present embodiment, it is also possible for a solo player to play for bonus levels by wagering buy-in wagers. Referring to FIG. 3a (Solo player) for the basic wager amount of $0.40, a solo player can play the base game. The solo player may play for bonus level 1 by wagering $0.50 in which $0.40 is allocated to the base game, and $0.10 is allocated as a buy-in to the level 1 bonus game. The solo player may play for bonus level 2 by wagering $0.60 in which $0.40 is allocated to the base game, and $0.20 is allocated as a buy-in to the level 2 bonus game. The solo player may play for bonus level 3 by wagering $0.70 in which $0.40 is allocated to the base game, and $0.30 is allocated as a buy-in to the level 3 bonus game. The solo player may play for bonus level 4 by wagering $0.80 in which $0.40 is allocated to the base game, and $0.40 is allocated as a buy-in to the level 4 bonus game.

In the embodiment described above, the number of people in a group determines the bonus level the group is eligible for. In another embodiment the total group wager may be used to determine the bonus level eligibility. In this embodiment, group wager levels may be established to grant eligibility to a corresponding bonus level. In order to be eligible for a bonus level, the total group wager must be at or over the wager level corresponding to that bonus level. In another embodiment, the number of players in the group determines a minimum bonus level available to the group, as described above referring to FIG. 3. That is, a group of two players is eligible to play for bonus level 2, a group of three players is eligible to play for bonus level 3 and a group of four players is eligible to play for bonus level 4. The total group wager determines whether the group is eligible to play for higher bonus levels than the minimum bonus levels.

In yet another embodiment, the number of teams competing may be used as a determining factor for level eligibility. That is, more teams competing would unlock higher bonus levels for play. One skilled in the art understands that any appropriate method for determining eligibility to play for a bonus level based on the group wager may be implemented.

In operation, referring to both FIG. 2 and FIG. 3, the bonus server 104 monitors the transactions in the plurality of gaming machines. As part of this monitoring process, the bonus server 104 determines the wager of a player. The qualifier 204 determines whether the player at a gaming machine 102 belongs to a group and how many players are in that group by accessing group related data from the group data repository 205. Based on that data and the wager, the qualifier 204 allocates the wager between the base game and bonus game as directed by the player and according to the appropriate table in FIG. 3. In this way, the level bonus award that player is qualified for is determined.

The base game is played in response to an input from the player. The player is paid any winnings from the play of the base game. In addition, if the symbol combination produced by the gaming machine 102 is a winning combination for the bonus game, the winner determiner 206 determines which bonus level, if any, the player is qualified for, and awards the player the money in the bonus level the player is qualified for.

For example, assume a winning combination for the bonus game has appeared on the gaming machine 102. In general, the bonus award is allocated to the players in the winning group in an appropriate manner. In the illustrated embodiment, the bonus award is allocated to the players as described below. If a player is not a member of a group, and has wagered only on the base game, then no bonus level award is made to the player, and payouts are determined by the pay table in the base game only. If the player is a solo player and has wagered an addition buy-in wager to play for, e.g. the level 2 bonus (e.g. $0.20 in FIG. 3a), then the level 2 bonus is awarded to the player.

Continuing the example, if the player is in a group of two, and has wagered only the base amount, then the level 2 bonus is awarded to and allocated amongst the two group members. If the player is in a group of three, and has wagered an additional buy-in wager to play for play for the level 4 bonus, then the level 4 bonus is awarded to and allocated amongst the three group members. One skilled in the art also understands that the probability of a group hitting the bonus combination is increased because there are more players playing for that bonus award. That is, if two people are playing for a bonus award, then the bonus combination is expected to occur twice as often for those two players than it would for a solo player.

One skilled in the art further understands that the size of groups, wager amounts or total group wagers may all be used to determine the frequency of bonus game wins. In this manner, a team that includes more players, or wagers more, or any combination, may be rewarded by an increased probability of winning a bonus level.

Allocation of bonus award amounts to the players in the group depends on the number of people in the group, and may be done in several ways. In one embodiment, the bonus award is allocated equally among the group members. In another embodiment, the bonus award is allocated according to the wager amounts per spin of the respective group members. One skilled in the art understands that any reasonable manner of allocating bonus awards to group members may be used.

The bonus game has been described in terms of providing access to bonus levels in response to the number of players in a group, among other things. However, one skilled in the art understands that the bonus game could also be configured as a level game. In such an embodiment, players and/or groups must win at one bonus level before they may progress to playing for the next bonus level.

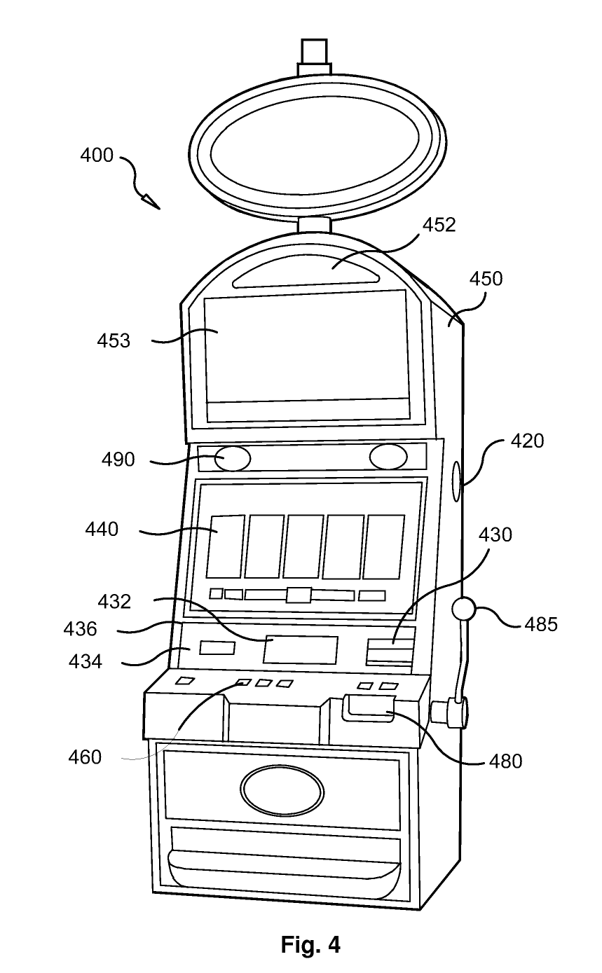

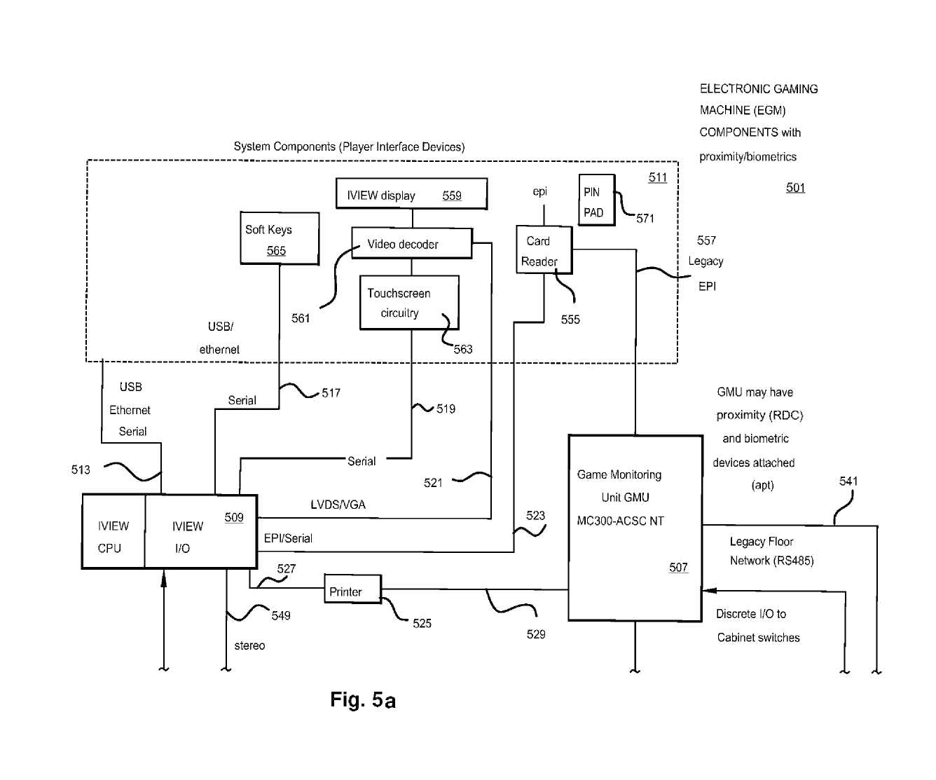

Referring to FIG. 4, gaming machine 400 capable of supporting various embodiments of the invention is shown, including cabinet housing 420, primary game display 440 upon which a primary game and feature game may be displayed, top box 450 which may display multiple progressives that may be won during play of the feature game, player-activated buttons 460, player tracking panel 436, bill/voucher acceptor 480 and one or more speakers 490. Cabinet housing 420 may be a self-standing unit that is generally rectangular in shape and may be manufactured with reinforced steel or other rigid materials which are resistant to tampering and vandalism. Cabinet housing 420 may alternatively be a handheld device including the gaming functionality as discussed herein and including various of the described components herein. For example, a handheld device may be a cell phone, personal data assistant, or laptop or tablet computer, each of which may include a display, a processor, and memory sufficient to support either stand-alone capability such as gaming machine 400 or thin client capability such as that incorporating some of the capability of a remote server. As another example, the cabinet housing 420 may be a personal computer, in any configuration such as a laptop or desktop or tower configuration. Such a personal computer includes a keyboard, mouse or touchpad or trackball, one or more display monitors, one or more processors, and memory sufficient to support the stand-alone capability of a gaming machine or of a thin client.

In one or more embodiments, cabinet housing 420 houses a processor, circuitry, and software (not shown) for receiving signals from the player-activated buttons 460, operating the games, and transmitting signals to the respective displays and speakers. Any shaped cabinet may be implemented with any embodiment of gaming machine 400 so long as it provides access to a player for playing a game. For example, cabinet 420 may comprise a slant-top, bar-top, or table-top style cabinet, including a Bally Cinevision™ or CineReels™ cabinet. The operation of gaming machine 400 is described more fully below.

The plurality of player-activated buttons 460 may be used for various functions such as, but not limited to, selecting a wager denomination, selecting a game to be played, selecting a wager amount per game, initiating a game, or cashing out money from gaming machine 400. Buttons 460 may be operable as input mechanisms and may include mechanical buttons, electromechanical buttons or touch screen buttons. Optionally, a handle 485 may be rotated by a player to initiate a game.

In one or more embodiments, buttons 460 may be replaced with various other input mechanisms known in the art such as, but not limited to, a touch screen system, touch pad, track ball, mouse, switches, toggle switches, or other input means used to accept player input such as a Bally iDeck™. One other example input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 420 may optionally include top box 450 which contains “top glass” 452 comprising advertising or payout information related to the game or games available on gaming machine 400. Player tracking panel 436 includes player tracking card reader 434 and player tracking display 432. The player tracking panel 136 may present a menu item, or pop up window allowing a player to send an invitation to, or receive an invitation from, another player, to join a group, as described above. Voucher printer 430 may be integrated into player tracking panel 436 or installed elsewhere in cabinet housing 420 or top box 450.

Game display 440 may present a game of chance wherein a player receives one or more outcomes from a set of potential outcomes. For example, one such game of chance is a video slot machine game. In other aspects of the invention, gaming machine 400 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 440 is, typically, a CRT or a flat-panel display in the form of, but not limited to, liquid crystal, plasma, electroluminescent, vacuum fluorescent, field emission, or any other type of panel display known or developed in the art. Game display 440 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 440 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference in its entirety for all purposes.

Game display 440 may also present information such as, but not limited to, player information, advertisements and casino promotions, graphic displays, news and sports updates, or even offer an alternate game. The game display may also present a menu item, or pop up window allowing the player to send an invitation to, or receive an invitation from, another player to form a group. This information may be generated through a host computer networked with gaming machine 400 on its own initiative or it may be obtained by request of the player using either one or more of the plurality of player-activated buttons 460; the game display itself if game display 440 comprises a touch screen or similar technology; buttons (not shown) mounted about game display 440 which may permit selections such as those found on an ATM machine, where legends on the screen are associated with respective selecting buttons; or any player input device that offers the required functionality.

Cabinet housing 420 incorporates a single game display 440. However, in alternate embodiments, cabinet housing 420 or top box 450 may house one or more additional displays 453 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

In the illustrated embodiment, the bonus levels (level 1, level 2, level 3 and level 4) may be displayed on the display 153 so that everyone can see what their current values are. In addition, groups may be graphically displayed on the display 153. For example, the groups displayed on the display 153 may be displayed in association with unique audio, or simply graphically, or with simple audio. For example, a unique color and/or sound may be associated with each group

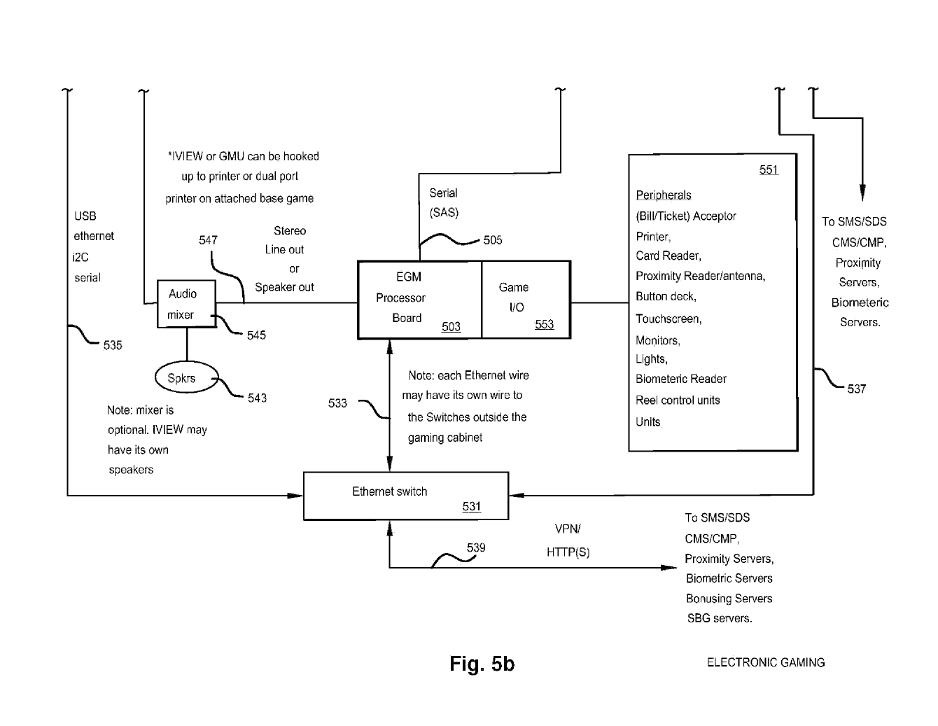

Referring to FIG. 5, electronic gaming machine 501 is shown in accordance with one or more embodiments. Electronic gaming machine 501 includes base game integrated circuit board 503 (EGM Processor Board) connected through serial bus line 505 to game monitoring unit (GMU) 507 (such as a Bally MC300 or ACSC NT), and player interface integrated circuit board (PIB) 509 connected to player interface devices 511 over bus lines 513, 517, 519, 521 and 523, respectively. Printer 525 is connected to PIB 509 and GMU 507 over bus lines 527 and 529, respectively. Base game integrated circuit board 503, PIB 509, and GMU 507 connect to Ethernet switch 531 over bus lines 533, 535 and 537, respectively. Ethernet switch 531 connects to a slot management system (SMS) and a casino management system (CMS) network over bus line 539. GMU 507 also may connect to the SMS and CMS network over bus line 541. Speakers 543 connect through audio mixer 545 and bus lines 547 and 549 to base game integrated circuit board 503 and PIB 509, respectively. Proximity and biometric devices and circuitry may be installed by upgrading a commercially available PIB 509, such as a Bally iView unit. Coding executed on base game integrated circuit board 503, PIB 509, and/or GMU 507 may be upgraded to integrate a game having adjustable multi-part indicia as is more fully described herein.

Peripherals 551 connect through I/O board 553 to base game integrated circuit board 503. For example, a bill/ticket acceptor is typically connected to a game input-output board 553 which is, in turn, connected to a conventional central processing unit (“CPU”) base game integrated circuit board 503, such as an Intel Pentium microprocessor mounted on a gaming motherboard. The I/O board 553 may be connected to base game integrated circuit board 503 by a serial connection such as RS-232 or USB or may be attached to the processor by a bus such as, but not limited to, an ISA bus, or by direct connections to the base game integrated circuit board 503 as a daughter board. The gaming motherboard may be mounted with other conventional components, such as are found on conventional personal computer motherboards, and loaded with a game program which may include a gaming machine operating system (OS), such as a Bally Alpha OS. Base game integrated circuit board 503 executes a game program that causes base game integrated circuit board 503 to play a game. In one embodiment, the game program provides a slot machine game having adjustable multi-part indicia. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 553 to base game integrated circuit board 503 which, in turn, assigns an appropriate number of credits for play in accordance with the game program. The player may further control the operation of the gaming machine by way of other peripherals 551, for example, to select the amount to wager via electromechanical or touch screen buttons. The game starts in response to the player operating a start mechanism such as a handle or touch screen icon. The game program includes a random number generator to provide a display of randomly selected indicia on one or more displays. In some embodiments, the random generator may be physically separate from gaming machine 500; for example, it may be part of a central determination host system which provides random game outcomes to the game program. Thereafter, the player may or may not interact with the game through electromechanical or touch screen buttons to change the displayed indicia. Finally, base game integrated circuit board 503 under control of the game program and OS compares the final display of indicia to a pay table. The set of possible game outcomes may include a subset of outcomes related to the triggering of a feature game. In the event the displayed outcome is a member of this subset, base game integrated circuit board 503, under control of the game program and by way of I/O Board 553, may cause feature game play to be presented on a feature display.

Predetermined payout amounts for certain outcomes, including feature game outcomes, are stored as part of the game program. Such payout amounts are, in response to instructions from base game integrated circuit board 503, provided to the player in the form of coins, credits or currency via I/O board 553 and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a wide area network (possibly including the Internet), a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to read/write (random access) memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 507 includes an integrated circuit board and GMU processor and memory including coding for network communications, such as the G2S (game-to-system) protocol promulgated by Gaming Standards Association, Las Vegas, Nev., used for system communications over the network. As shown, GMU 507 may connect to card reader 555 through bus 557 and may thereby obtain player card information and transmit the information over the network through bus 541. Gaming activity information may be transferred by the base game integrated circuit board 503 to GMU 507 where the information may be translated into a network protocol, such as S2S, for transmission to a server, such as a player tracking server, where information about a player's playing activity may be stored in a designated server database.

PIB 509 includes an integrated circuit board, PID processor, and memory which includes an operating system, such as Windows CE, a player interface program which may be executable by the PID processor and various input/output (I/O) drivers for respective devices which connect to PIB 509. These devices include player interface devices 511. The PIB 509 may further include various games or game components playable on PIB 509 or playable on a connected network server for which PIB 509 is operable as the player interface. PIB 509 connects to card reader 555 through bus 523, display 559 through video decoder 561 and bus 521, such as an LVDS or VGA bus.

As part of its programming, the PID processor executes coding to drive display 559 to provide messages and information to a player. Touch screen circuitry 563 interactively couples display 559 and video decoder 561 to PIB 509, such that a player may input information and cause the information to be transmitted to PIB 509 via the touch screen 563 either on the player's initiative or responsive to a query by PIB 509. Additionally soft keys 565 connect through bus 517 to PIB 509 and operate together with display 559 to provide information or queries to a player and receive responses or queries from the player. PIB 509, in turn, communicates over the CMS/SMS network through Ethernet switch 531 and busses 535, 539 and with respective servers, such as a player tracking server.

Player interface devices 511 are linked into the virtual private network of the system components in gaming machine 501. The system components include the iView processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection 505 and is connected to various servers using, for example, HTTPs over Ethernet. Through this connection, firmware, media, operating system software, gaming machine configurations can be downloaded to the system components from the servers. This data is authenticated prior to install on the system components.

The system components include the iView processing board and game monitoring unit (GMU) processing board. The GMU and iView can combined into one like the commercially available Bally GTM iView device. This device may have a video mixing technology to mix the EGM processor's video signals with the iView display onto the top box monitor or any monitor on the gaming device.

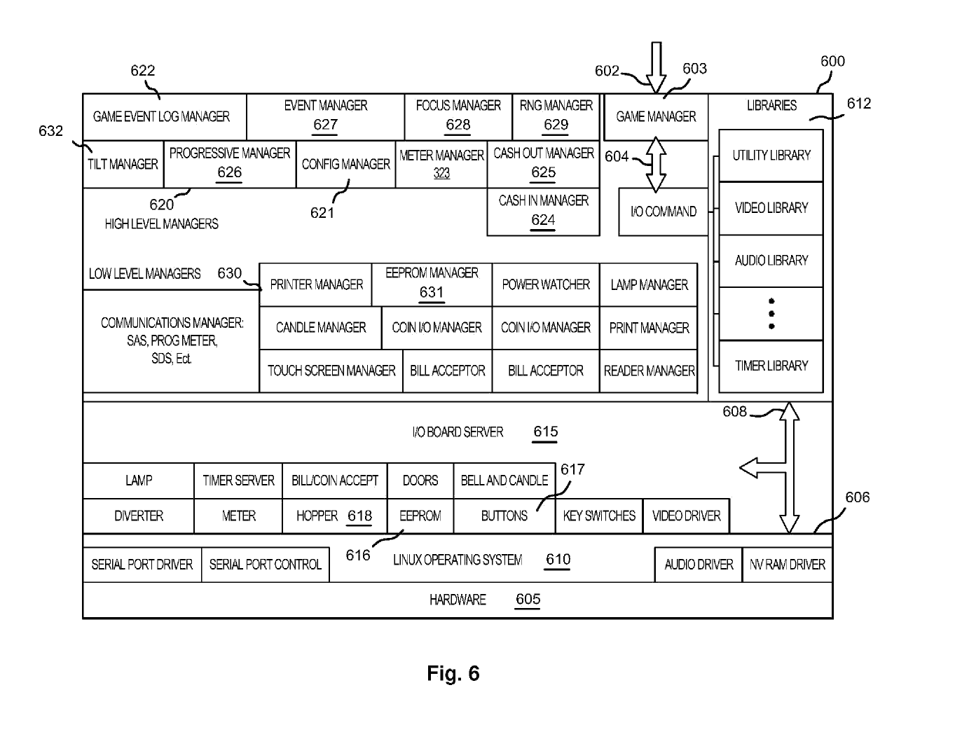

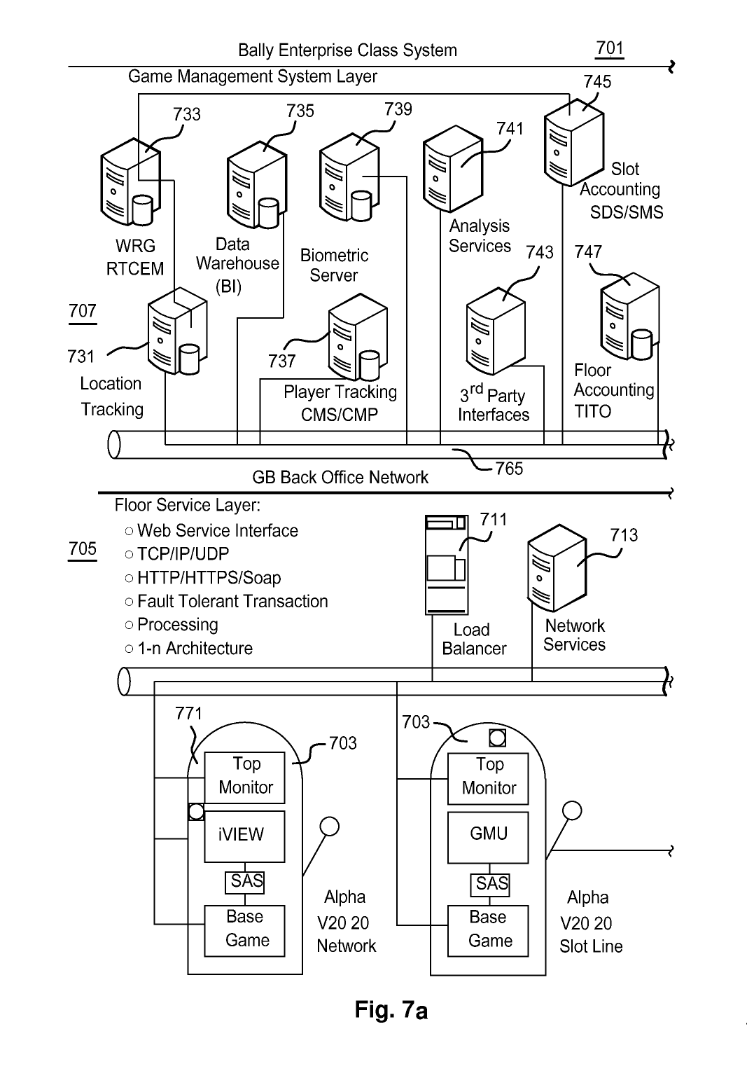

In accordance with one or more embodiments, FIG. 6 is a functional block diagram of a gaming kernel 600 of a game program under control of base game integrated circuit board 503 (FIG. 5). The game program uses gaming kernel 600 by calling into application programming interface (API) 602, which is part of game manager 603. The components of game kernel 600 as shown in FIG. 6 are only illustrative, and should not be considered limiting. For example, the number of managers may be changed, additional managers may be added or some managers may be removed without deviating from the scope and spirit of the invention.

As shown in the example, there are three layers: a hardware layer 605; an operating system layer 610, such as, but not limited to, Linux; and a game kernel layer 600 having game manager 603 therein. In one or more embodiments, the use of a standard operating system 610, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 600 executes at the user level of the operating system 610, and itself contains a major component called the I/O Board Server 615. To properly set the bounds of game application software (making integrity checking easier), all game applications interact with gaming kernel 600 using a single API 602 in game manager 603. This enables game applications to make use of a well-defined, consistent interface, as well as making access points to gaming kernel 600 controlled, where overall access is controlled using separate processes.

For example, game manager 603 parses an incoming command stream and, when a command dealing with I/O comes in (arrow 604), the command is sent to an applicable library routine 612. Library routine 612 decides what it needs from a device, and sends commands to I/O Board Server 615 (see arrow 608). A few specific drivers remain in operating system 610's kernel, shown as those below line 606. These are built-in, primitive, or privileged drivers that are (i) general (ii) kept to a minimum and (iii) are easier to leave than extract. In such cases, the low-level communications is handled within operating system 610 and the contents passed to library routines 612.

Thus, in a few cases library routines may interact with drivers inside operating system 610, which is why arrow 608 is shown as having three directions (between library utilities 612 and I/O Board Server 615, or between library utilities 612 and certain drivers in operating system 610). No matter which path is taken, the logic needed to work with each device is coded into modules in the user layer of the diagram. Operating system 610 is kept as simple, stripped down, and common across as many hardware platforms as possible. The library utilities and user-level drivers change as dictated by the game cabinet or game machine in which it will run. Thus, each game cabinet or game machine may have an base game integrated circuit board 503 (FIG. 5) connected to a unique, relatively dumb, and as inexpensive as possible I/O adapter board 540, plus a gaming kernel 600 which will have the game-machine-unique library routines and I/O Board Server 615 components needed to enable game applications to interact with the gaming machine cabinet. Note that these differences are invisible to the game application software with the exception of certain functional differences (i.e., if a gaming cabinet has stereo sound, the game application will be able make use of API 602 to use the capability over that of a cabinet having traditional monaural sound).

Game manager 603 provides an interface into game kernel 600, providing consistent, predictable, and backwards compatible calling methods, syntax, and capabilities by way of game application API 602. This enables the game developer to be free of dealing directly with the hardware, including the freedom to not have to deal with low-level drivers as well as the freedom to not have to program lower level managers 630. The lower level managers 630 may be accessed through game manager 603's interface 602 if a programmer has the need. In addition to the freedom derived from not having to deal with the hardware level drivers and the freedom of having consistent, callable, object-oriented interfaces to software managers of those components (drivers), game manager 603 provides access to a set of high level managers 620 also having the advantages of consistent callable, object-oriented interfaces, and further providing the types and kinds of base functionality required in casino-type games. Game manager 603, providing all the advantages of its consistent and richly functional interface 602 as supported by the rest of game kernel 600, thus provides a game developer with a multitude of advantages.

Game manager 603 may have several objects within itself, including an initialization object (not shown). The initialization object performs the initialization of the entire game machine, including other objects, after game manager 603 has started its internal objects and servers in appropriate order. In order to carry out this function, the kernel's configuration manager 621 is among the first objects to be started; configuration manager 621 has data needed to initialize and correctly configure other objects or servers.

The upper level managers 620 of game kernel 600 may include game event log manager 622 which provides, at the least, a logging or logger base class, enabling other logging objects to be derived from this base object. The logger object is a generic logger; that is, it is not aware of the contents of logged messages and events. The log manager's (622) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 623 manages the various meters embodied in the game kernel 600. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 623 receives its initialization data for the meters, during start-up, from configuration manager 621. While running, the cash in (624) and cash out (625) managers call the meter manager's (623) update functions to update the meters. Meter manager 623 will, on occasion, create backup copies of the soft meters by storing the soft meters' readings in EEPROM. This is accomplished by calling and using the low level 630 EEPROM manager 631.

In accordance with still other embodiments, progressive manager 626 manages progressive games playable from the game machine. Event manager 627 is generic, like log manager 622, and is used to manage various gaming machine events. Focus manager 628 correlates which process has control of various focus items. Tilt manager 632 is an object that receives a list of errors (if any) from configuration manager 621 at initialization, and during game play from processes, managers, drivers, etc. that may generate errors. Random number generator manager 629 is provided to allow easy programming access to a random number generator (RNG), as a RNG is required in virtually all casino-style (gambling) games. RNG manager 629 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 625 has the responsibility of configuring and managing monetary output devices. During initialization, cash out manager 625, using data from configuration manager 621, sets the cash out devices correctly and selects any selectable cash out denominations. During play, a game application may post a cash out event through the event manager 627 (the same way all events are handled), and using a call-back posted by cash out manager 625, cash out manager 625 is informed of the event. Cash out manager 625 updates the credit object, updates its state in non-volatile memory, and sends an appropriate control message to the device manager that corresponds to the dispensing device. As the device dispenses dispensable media, there will typically be event messages being sent back and forth between the device and cash out manager 625 until the dispensing finishes, after which cash out manager 625, having updated the credit manager and any other game state (such as some associated with meter manager 623) that needs to be updated for this set of actions, sends a cash out completion event to event manager 627 and to the game application thereby. Cash in manager 624 functions similarly to cash out manager 625, only controlling, interfacing with, and taking care of actions associated with cashing in events, cash in devices, and associated meters and crediting.

In a further example, in accordance with one or more embodiments, I/O server 615 may write data to the gaming machine EEPROM memory, which is located in the gaming machine cabinet and holds meter storage that must be kept even in the event of power failure. Game manager 603 calls the I/O library functions to write data to the EEPROM. The I/O server 615 receives the request and starts a low priority EEPROM thread 616 within I/O server 615 to write the data. This thread uses a sequence of 8 bit command and data writes to the EEPROM device to write the appropriate data in the proper location within the device. Any errors detected will be sent as IPC messages to game manager 603. All of this processing is asynchronous.

In accordance with one embodiment, button module 617 within I/O server 615, polls (or is sent) the state of buttons every 2 ms. These inputs are debounced by keeping a history of input samples. Certain sequences of samples are required to detect a button was pressed, in which case the I/O server 615 sends an inter-process communication (IPC) event to game manager 603 that a button was pressed or released. In some embodiments, the gaming machine may have intelligent distributed I/O which debounces the buttons, in which case button module 617 may be able to communicate with the remote intelligent button processor to get the button events and simply relay them to game manager 603 via IPC messages. In still another embodiment, the I/O library may be used for pay out requests from the game application. For example, hopper module 618 must start the hopper motor, constantly monitor the coin sensing lines of the hopper, debounce them, and send an IPC message to the game manager 603 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application number 60/313,743, entitled “Form Fitting Upgrade Board Set For Existing Game Cabinets,” filed Aug. 20, 2001; said patent and provisional are both fully incorporated herein by explicit reference.

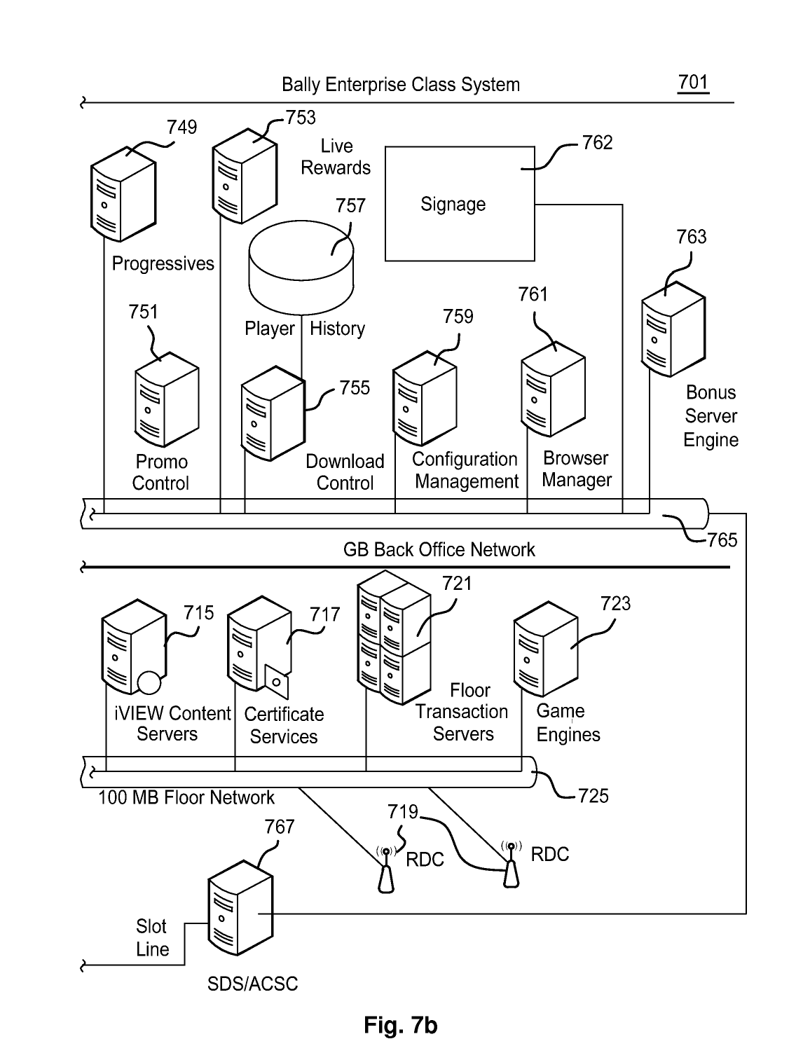

Referring to FIG. 7, enterprise gaming system 701 is shown in accordance with one or more embodiments. Enterprise gaming system 701 may include one casino or multiple locations and generally includes a network of gaming machines 703, floor management system (SMS) 705, and casino management system (CMS) 707. SMS 705 may include load balancer 711, network services servers 713, player interface (iView) content servers 715, certificate services server 717, floor radio dispatch receiver/transmitters (RDC) 719, floor transaction servers 721 and game engines 723, each of which may connect over network bus 725 to gaming machines 703.

CMS 707 may include location tracking server 731, WRG RTCEM server 733, data warehouse server 735, player tracking server 737, biometric server 739, analysis services server 741, third party interface server 743, slot accounting server 745, floor accounting server 747, progressives server 749, promo control server 751, feature game (such as Bally Live Rewards) server 753, download control server 755, player history database 757, configuration management server 759, browser manager 761, connecting through bus 765 to server host 767 and gaming machines 703. A bonus server computer 763, corresponding to the bonus server 104 in FIG. 1 and FIG. 2, is also coupled to the server host 767 and gaming machines 703 through bus 765.

The various servers and gaming machines 703 may connect to the network (725, 765) with various conventional network connections (such as, for example, USB, serial, parallel, RS485, Ethernet). Additional servers which may be incorporated with CMS 707 include a responsible gaming limit server (not shown), advertisement server (not shown), and a control station server (not shown) where an operator or authorized personnel may select options and input new programming to adjust each of the respective servers and gaming machines 703. SMS 705 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 703 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 707 and/or SMS 705 servers and devices, firmware, media, operating systems, and configurations may be downloaded to the system components of respective gaming machines for upgrading or managing floor content and offerings in accordance with operator selections or automatically depending upon CMS 707 and SMS 705 master programming. The data and programming updates to gaming machines 703 are authenticated using conventional techniques prior to install on the system components.

In various embodiments, any of the gaming machines 703 may be a mechanical reel spinning slot machine or a video slot machine or a gaming machine offering one or more of the above described games including a group play game. Alternately, gaming machines 703 may provide a game with a simulated musical instrument interface as a primary or base game or as one of a set of multiple primary games selected for play by a random number generator. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. application Ser. No. 11/938,079, entitled “Networked System and Method for Group Play Gaming,” filed on Nov. 9, 2007, which is hereby incorporated by reference in its entirety for all purposes.

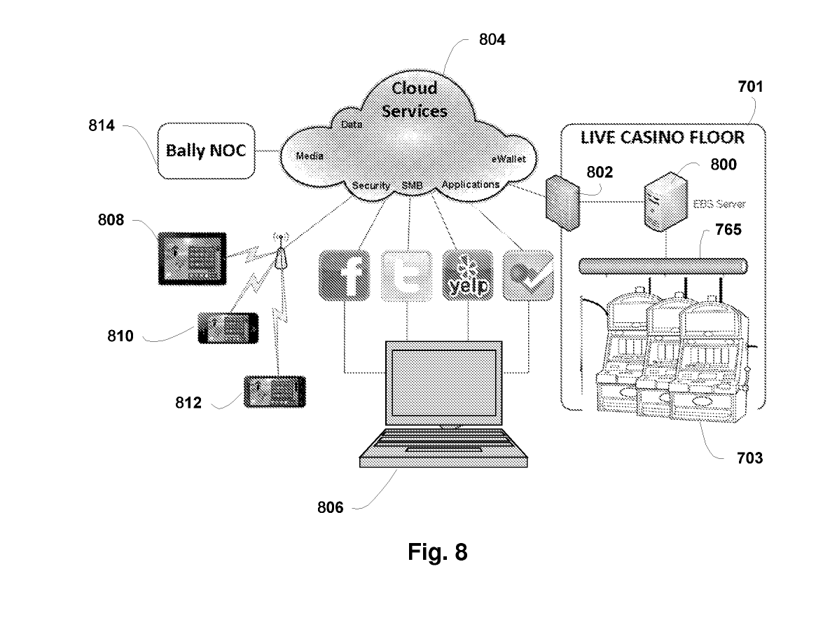

All or portions of the present invention may also be implemented by or promoted through a system as suggested in FIG. 8. The gaming system 701 (illustrated in detail in FIG. 7), may be hosted at a casino property enterprise, across several casino enterprises or by a third party host. As described above, the gaming system 701 has a network communication bus 765 providing communication between the gaming terminals 703 and various servers. To provide the functionality illustrated in FIG. 8, a bonusing server 800, such as a Bally Elite Bonusing Server is connected to the network communication bus 765 for communication to the gaming system 701, the gaming terminals 703 and the various servers and other devices as described above. The bonusing server 800 is in communication with a cloud computing/storage service 804 through a secure network firewall 802. The cloud computing/storage service 804 may be hosted by the casino enterprise, a licensed third party or if permitted by gaming regulators an unlicensed provider. For example the cloud service 804 may be as provided by Microsoft® Private Cloud Solutions offered by Microsoft Corp. of Redmond, Wash., USA. The cloud service 804 provides various applications which can be accessed by and delivered to, for example, personal computers 806, portable computing devices such as computer tablets 808, personal digital assistants (PDAs) 810 and cellular devices 812 such as telephones and smart phones. As an example, the cloud service 804 may store and host: (a) an eWallet application, (b) a casino or player-centric applications such as downloadable or accessible applications including games, promotional material or applications directed to and/or affecting a casino customers interaction with a casino enterprise (such as accessing the players casino account, establishing casino credit or the like), (c) providing bonuses to players through system wide bonusing (SMB) or specific bonusing or comps to players, or (d) other applications. The cloud service 804 includes security to provide for secure communication within the cloud service 804, between the player/users and the cloud service 804, and between the cloud service 804 and the gaming system 701. Security applications may be through encryption, the use of personal identification numbers (PINS) or other devices and systems. As suggested in FIG. 8, the cloud service 804 stores player/user data retrieved from players/users and from the gaming system 701.

The players/users may access the cloud service 804 and the applications and data provided thereby through the Internet or through broadband wireless cellular communication systems and any intervening short range wireless communication such as Bluetooth® (a registered trademark of Bluetooth SIG, Inc.) or WiFi. The players/users may further access the applications and data through various social media offerings such as Facebook, Twitter, Yelp, MySpace, LinkedIn or the like.

As but an example, a player/user may have a player account with a casino enterprise Z. That account may include data such as the player's credit level, their rating and their available comps. The account may further track any certificates, and the present value thereof, the player may have won as a result of the playing a game according to the present invention. At their smart phone 812 the player/user sends a request to the cloud service 804 (perhaps through a previously downloaded application) to receive the status of their available comps such as how many comp points they have and what may be available through redemption of those points (e.g. lodging, cash back, meals or merchandise). The response to the request may present casino promotions, graphics or other advertising to the player/user. The application, to support such a request, would typically require the player/user to enter a PIN. The cloud service 804 forwards the inquiry to the bonusing servicer 800 which, in turn, confirms the PIN and retrieves the requested information from the data warehouse 735 (FIG. 7) or player tracking CMS/CMP server 737.

Alternatively the data may be stored in the cloud service 804 and routinely updated from the data warehouse 735 or player tracking CMS/CMP server 737. In this instance the request would be responded to from data residing with the cloud service 804. The information is formatted by the cloud server 804 application and delivered to the player/user. The delivery may be formatted based upon the player/user's device operating system (OS), display size or the like.

The cloud service 804 may also host game applications to provide virtual instances of games for free, promotional, or where permitted, P2P (Pay to Play) supported gaming. Third party developers may also have access to placing applications with the cloud service 804 through, for example a national operations center (for example, Bally NOC 814). A game software manufacturer such as Bally Gaming, Inc. may also provide game applications on its own or on behalf of the casino enterprise.

Other media such as advertising, notices (such as an upcoming tournament) may also be provided to the cloud service 804. When a player/user accesses the cloud service 804 certain media may be delivered to the player/user in a manner formatted for their application and device.

Although the description above contains many specificities, these should not be construed as limiting the scope of the invention but as merely providing an illustration of the presently preferred embodiment of the invention. Thus the scope of this invention should be determined by the appended claims and their legal equivalents.

What is claimed is:

1. In a cooperative/competitive gaming system including a plurality of gaming machines, a bonus server and a network for coupling the plurality of gaming machines to the bonus server, a method for operating a cooperative/competitive game, comprising:
accumulating two or more bonus awards representing respectively different bonus levels in the bonus server;
facilitating players to form groups of two or more players by and storing data representing the formed groups of players in the bonus server;
receiving data representing wagers and game results from the gaming machines in the bonus server;
determining if a bonus level award is won by a player in a group based on the wager representative data, the group representative data, and the game results representative data; and
allocating the bonus level award among the players in the winning group of players.

2. The method of claim 1 wherein the bonus awards are accumulated from buy-in wagers by players.

3. The method of claim 1 wherein the bonus awards are accumulated from a portion of all wagers by players.

4. The method of claim 1 wherein the bonus awards are accumulated as a mystery bonus.

5. The method of claim 1 wherein facilitating players to form groups occurs in one or more of the following environments: (a) at the gaming machines; (b) in a gaming establishment; and (c) the Internet.

6. The method of claim 1 wherein determining if a bonus level is to be awarded comprises determining a bonus level to be awarded based on the number of people in the winning group.

7. The method of claim 6 wherein determining if a bonus level is to be awarded further comprises determining a bonus level based on receiving a buy-in wager from a player.

8. The method of claim 1 wherein determining if a bonus level is to be awarded comprises determining a bonus level based on receiving a buy-in wager from a player.

9. The method of claim 1 wherein allocating a bonus level award among the winning group of players comprises allocating an equal amount of the bonus level to each player in the group of players.

10. The method of claim 1 wherein allocating a bonus level award among the winning group of players comprises allocating a proportion of the bonus level to each player in the group of players based on the wager of each player.
